(19) United States
(12) Patent Application Publication
(10) Pub. No.: US 2026/0240200 A1
(43) Pub. Date: Aug. 20, 2026

(54) COMPOSITION COMPRISING AN N-GUANYLAMINO ACID FOR DRINKING WATER APPLICATION

(71) Applicant: Evonik Operations GmbH, Essen (DE)

(72) Inventors: Axel RONNEBURG, Hanau (DE); Arif MUSIC, Hanau (DE); Ursula RIESEN, Rodenbach (DE); Anja NORDSCHILD, Oberursel (DE); Rose WHELAN, Ambrosden (GB); Martina KLÜNEMANN, Frankfurt (DE)

(73) Assignee: Evonik Operations GmbH, Essen (DE)

(21) Appl. No.: 19/471,205

(22) PCT Filed: Mar. 25, 2024
(86) PCT No.: PCT/EP2024/057896

§ 371 Date: Sep. 30, 2025

(30) Foreign Application Priority Data
Apr. 3, 2023 (EP) 23166306

(51) Int. Cl. A23K 20/142; A23K 10/18; A23K 20/105; A23K 20/116; A23K 20/22; A23K 50/10; A23K 50/30; A23K 50/75

(52) U.S. Cl. CPC A23K 20/142; A23K 10/18; A23K 20/105; A23K 20/116; A23K 20/22; A23K 50/10; A23K 50/30; A23K 50/75

(57) ABSTRACT

A composition may include an N-guanylamino acid, a carbon dioxide producing compound, and a gas releasing compound. The equivalent ratio of the gas releasing compound to the carbon dioxide producing compound may be 1 or more. The molar ratio of the carbon dioxide producing compound to the N-guanylamino acid may be 1 or more.

The present invention relates to a composition comprising an N-guanylamino acid, a carbon dioxide producing compound, and a gas releasing compound, wherein the equivalent ratio of the gas releasing compound to the carbon dioxide producing compound is 1 or more, and the molar ratio of the carbon dioxide producing to the N-guanylamino acid is 1 or more, and a diet comprising said composition for use in the treatment and/or prophylaxis of heat stress, transport stress or any other stress-related conditions in poultry.

N-guanylamino acids are derivatives of amino acids with a guanidine group, which are obtainable by addition of cyanamide to the amino acid in question. The most important N-guanylamino acid is guanidino acetic acid (GAA), also known as N-guanylglycine. It is an endogenous substance in animals and humans, which takes a central role in the biosynthesis of creatine. Creatine can be taken by the diet and/or be formed endogenously. Its biosynthesis proceeds from glycine and L-arginine. Guanidinoacetic acid is formed in the mammalian organism, primarily in the kidneys, by transferring the guanidine group of L-arginine by the enzyme L-Arg: Gly-amidinotransferase (AGAT) to the amino acid glycine. Starting from L-arginine, L-ornithine is thus produced, which is then metabolized in the urea cycle by carbamoylation to L-citrulline. In a further step, guanidinoacetic acid is methylated to creatine with S-adenosyl methionine by the enzyme guanidinoacetate N-methyltransferase (GAMT). Guanidinoacetic acid was first synthesized in 1861 by Adolph Strecker by addition of cyanamide to glycine in aqueous solution, specifically in a weak aqueous solution of ammonia (M. Strecker, compt. Rend. 1861, 52, 1212; cited in Ber. Chem. Ges. (now, Eur. J. Inorg. Chem.) 1908, 41, 4385). In later publications, guanidinoacetic acid was prepared from cyanamide and glycine in iso-propanol as solvent with sodium hydroxide as base (CN 102329250 A) or with sodium carbonate as base (CN101462983 A).

Alternatively, N-guanylamino acids, e.g., GAA, can also be produced in fermentation processes by transamidination reactions in which the amidino group of arginine is transferred to various amidino group acceptors, such as guanidinoacetate, 3-guanidinopropionic acid, 4-guanidinobutyric acid, 2-guanidinoethanol, hydroxyguanidine, and homoarginine, among others. The fermentative production of guanidinoacetic acid has been extensively studied. For example, WO 2021/122400 A1 and WO 2022/00828 A1 disclose the fermentative production of GAA using a specific developed strain, and Yiwen Zhang et al. discloses the fermentative production of GAA using a whole cell catalyst system (Yiwen Zhang, Hang Zhou, Yong Tao, and Baixue Lin, ACS Synth. Biol. 2020, 9, 2066-2075).

Supplementation of GAA allows for an optimal supply of creatine in the organism, which in turn positively influences the energy transport in the muscle cells. Typically, GAA may be simply supplemented to the diet given to animals. In particular, under certain situations such as heat stress, transport stress and during or after illness, animals often have an increased energy requirement, but consume less food while at the same time the animals have an increased need for water supply, e.g., drinking. In principle, this increased energy requirement can be covered by supplementation of GAA. However, compared to creatine, guanylamino acids have the disadvantage of a very poor solubility in water. For example, guanidinoacetic acid has a very poor solubility in water of only 1 g in 278 ml water at 15° C.

Several approaches were taken to solve this issue. For example, CN 115137016 A discloses a nutritional preparation for livestock and poultry and a method for preparing said nutritional preparation. The nutritional preparation comprises 40 to 80 parts by weight of guanidinoacetic acid, 8 to 20 parts by weight of anhydrous sodium sulfate, 1 to 15 parts of sweetening agent, 3 to 10 parts by weight of citric acid, 10 to 40 parts by weight of glucose, 8 to 20 parts of beneficial powder and 1 to 13 parts by weight of ammonium bicarbonate. However, while this preparation is called water-soluble in CN 115137016, experiments have shown that a preparation according to CN 115137016 does not dissolve in water without stirring. Therefore, it needs a mechanical stirrer to get N-guanylamino acids, such as guanidinoacetic acid, dissolved. However, mechanically stirred tanks or troughs are expensive and therefore quite rare at farms. A further disadvantage of stirred tanks or troughs is the higher risk of bacterial contamination.

A liquid application of N-guanylamino acids, such as guanidinoacetic acid, would be a different approach to solve the dissolution problems associated with this type of compounds. For example, US 2009/0297656 A1 discloses a liquid formulation for human and animal nutrition, consisting of an aqueous solution, a guanidinoacetic acid component and at least one methyl group donor from the group of choline, methionine and betaine.

WO 2021/008848 A1 discloses a concentrate for producing a wetting solution, containing an aqueous solution of guanidinoacetic acid. In detail, this concentrate comprises an aqueous solution containing guanidinoacetic acid and at least one salt from the group of calcium chloride and magnesium chloride, the solution of which contains, based on the total weight of the solution, a) 0.5 to 4 wt.-% of guanidinoacetic acid, and 10 to 70 wt.-% calcium chloride and/or magnesium chloride, and c) residual water, wherein the ingredients a) and b) are present in the water in dissolved form. The large proportion of magnesium chloride or calcium chloride in this concentrate probably serves to improve the solubility of guanidinoacetic acid. This results in a rather high salt concentration in tanks or roughs, which, however, is also undesired at farms and can possibly intoxicate the animals.

Accordingly, there was still a need for an N-guanylamino acid, e.g., GAA, comprising composition, which allows for an improved dissolution of the N-guanylamino acid, e.g., GAA, in water.

It was found that this problem is solved by increasing the kinetics for dissolving an N-guanylamino acid, e.g., GAA, in water. In detail, this problem is solved in that the N-guanylamino acid, e.g., GAA, comprising composition also contains compounds which allow for the release of carbon dioxide. It is believed that the sparkling effect resulting from the release of carbon dioxide leads to a better homogeneity of the N-guanylamino acid, e.g., GAA, in water. This reduces the tendency that agglomerates are formed, and it breaks down potentially formed agglomerates during the N-guanylamino production, which would precipitate.

One object of the present invention is therefore a composition comprising an N-guanylamino acid, e.g., GAA, a carbon dioxide producing compound, and a gas releasing compound, wherein the equivalent ratio of the gas releasing compound to the carbon dioxide producing compound is 1 or more, and the molar ratio of the carbon dioxide producing compound to the N-guanylamino acid is 1 or more.

This composition is particularly suitable for drinking water application.

The carbon dioxide producing compound reacts with the gas releasing compound in the presence of water to release carbon dioxide. As a result, the dissolution process of the N-guanylamino acid is greatly accelerated.

In order to provide or produce carbon dioxide, it is preferred that the carbon dioxide producing compound is a salt of carbonic acid.

In an embodiment of the composition according to the present invention the carbon dioxide producing compound is therefore an alkali hydrogen carbonate, alkaline earth hydrogen carbonate, ammonium hydrogen carbonate, alkali carbonate, an alkaline earth carbonate or a mixture of any of these.

In a preferred embodiment of the composition according to the present invention the carbon dioxide producing compound is sodium hydrogen carbonate, potassium hydrogen carbonate, ammonium hydrogen carbonate, and/or a mixture of any of these.

In the present invention, the gas releasing compound reacts with the carbon dioxide producing compound, preferably a salt of carbonic acid, in the presence of water to release carbon dioxide. In principle, the underlying chemical reaction is therefore an acid-base reaction, the hydroxonium ions (H₃O⁺) provided by the gas releasing compound react with the carbonate ions (CO₃²⁻) or hydrogen carbonate ions (HCO₃) under formation of carbonic acid (H₂CO₃). Said molecule rapidly converts to water and carbon dioxide in the presence of water under ambient pressure and room temperature, which results in the effervescent or sparkling effect and the greatly accelerated dissolution of the N-guanylamino acid.

It is therefore preferred that the gas releasing compound in the composition according to the present invention is an acid, e.g., an inorganic acid, an organic acid, or a mixture of these.

The use of a solid organic acid allows to provide the composition according to the present invention in solid form. A solid form of the composition according to the present invention allows for an easier handling of the composition, an easier dosing, and a more efficient transport. It is therefore preferred that the composition according to the present invention is a solid composition.

In one embodiment of the composition according to the present invention the gas releasing compound is therefore a solid organic acid.

In a preferred embodiment of the composition according to the present invention the gas releasing compound is citric acid, tartaric acid, malic acid and/or a mixture of any of these.

In the context of the present invention the term equivalent ratio therefore denotes the ratio of the gas releasing compound to the carbon dioxide producing compound to give one molecule of carbon dioxide. For example, where the gas releasing compound is citric acid with 3 carboxylic acid groups and the carbon dioxide producing compound is sodium hydrogen carbonate (NaHCO₃), 3 equivalent citric acid react with 3 sodium hydrogen carbonate to give 3 equivalent carbon dioxide. Here, the equivalent ratio of the gas releasing compound to the carbon dioxide producing compound is 1:1. In another example, where the gas releasing compound is citric acid with 3 carboxylic acid groups and the carbon dioxide producing compound is sodium carbonate (Na₂CO₃), 6 equivalent citric acid react with 3 equivalent sodium carbonate to give 3 equivalent carbon dioxide. Here, the equivalent ratio of the gas releasing compound to the carbon dioxide producing compound is 2:1.

Preferably, the equivalent ratio of the gas releasing compound to the carbon dioxide producing compound ranges from 1 to 3 in the composition according to the present invention.

In order to guarantee that carbon dioxide is produced or provided as completely as possible, it is preferred that the equivalent ratio of the gas releasing to the gas producing compound is at least 1.05:1.

The present invention allows to provide N-guanylamino acid, e.g., GAA, comprising compositions with a higher amount of N-guanylamino acid, e.g., GAA, than in the compositions of the prior art, for example the mixture of WO 2021/008848 A1.

In another embodiment the composition according to the present invention comprises more than 4 wt.-% of the N-guanylamino acid, e.g., GAA, based on the total weight of the composition.

Preferably, the composition according to the present invention comprises from 5 to 25 wt.-%, from 5 to 12 wt.-%, or from 5 to 15 wt.-% of the N-guanylamino acid, e.g., GAA, based on the total weight of the composition.

The N-guanylamino acid of the highest relevance, in particular in the field of animal nutrition is guanidinoacetic acid.

In a further embodiment of the composition according to the present invention the N-guanylamino acid is therefore guanidinoacetic acid.

The composition according to the present invention may further comprise additional components. A suitable further component is a biologically available form of pyrroloquinoline quinone.

Poultry receiving administration of the composition according to the present invention, further comprising a biologically available form of pyrroloquinoline quinone, showed improved growth performance of broilers throughout all phases. Surprisingly, this effect is observed under any conditions, i.e., even when no heat stress is applied to poultry. Pyrroloquinoline quinone (PQQ) is a key redox cofactor in animal and human nutrition (Mitchell et al., Analytical Biochemistry 1999, 269, 317; Noji et al., Journal of Agricultural and Food Chemistry 2007, 55, 7258). The main effect of PQQ is to bind to proteins within cells and to act as an antioxidant, being recycled in the cell by glutathione. It is considered a vitamin-like substance (Kasahara et al., Nature 2003, 422, 832; Felton et al., Nature 2005, 433, E10; Rucker et al., Nature 2005, 433, E10-11; Ames et al., PNAS 2018, 115, 10836) and in comparison with other antioxidants, such as ascorbic acid (vitamin C), PQQ exerts a positive effect on mitochondrial biogenesis acting directly on the animals' energy metabolism, while other antioxidants have either no effect or show a reduction in mitochondrial function (Harris et al., Journal of Nutritional Biochemistry 2013, 24, 2076). Therefore, use of PQQ aims to improve the performance of broilers by increasing intracellular ATP levels through enhancement of mitochondrial biogenesis.

On the other hand, guanidino acetic acid (GAA) improves the transport of energy from the mitochondria into the cytoplasm by increasing the availability of creatine. In the mitochondria creatine binds to the phospho-group of adenosine triphosphate ATP and in the cytoplasm phospho-creatine releases it back onto ADP. It is expected that GAA should also support broilers suffering from oxidative stress, especially heat stress, through its antioxidative properties, for example by reducing electron-leakage and disturbing in the O₂-radical mechanism. Since PQQ improves mitochondrial health and ATP production and GAA improves energy transport from ATP, it is believed that a combination of PQQ and GAA interacts beneficially on a metabolic level improving ATP production and distribution within cells and that this effect is even enhanced under heat stress conditions as higher energy availability and lower oxidative stress would allow cells to deal with consequences of heat stress more efficiently.

In another embodiment the composition according to the present invention further comprises a biologically available form of pyrroloquinoline quinone.

In the context of the present invention the term biologically active form is used as known to the person skilled in the art and denotes the form of a compound, here PQQ, that allows to affect biological processes, beyond the nutritional value, in a way which has an impact on body function.

PQQ is a tricarboxylic acid with poor solubility in water. Therefore, the present invention uses a biologically active form of PQQ. In principle, the biologically active form of PQQ is not subject to any limitations. Notwithstanding, it is preferred that the biologically active form of pyrroloquinoline quinone is a pyrroloquinoline quinone salt (PQQ salt), because a pyrroloquinoline quinone salt provides the PQQ with an improved water solubility which is beneficial for a biological active form of PQQ and for faster dissolution in aqueous applications, e.g., in drinking water for poultry.

In an embodiment of the composition according to the present invention the biologically active form of pyrroloquinoline quinone is a pyrroloquinoline quinone salt (PQQ salt). In the context of the present invention, the PQQ salt is not subject to any limitations and can comprise an inorganic or organic cation. In the context of the present invention the term inorganic cation is used as known to the person skilled in the art and denotes any type of simple cation containing only a positively charged ion, for example, a monovalent cation, e.g., an ammonium cation NH₄⁺, an alkali metal cation, such as Li⁺, Na⁺, and K⁺, or a monovalent copper ion Cut, a divalent cation, e.g., an alkaline earth metal cation, such as Mg²⁺, Ca²⁺, and Ba²⁺, or a divalent iron cation Fe²⁺, a zinc cation Zn²⁺, or a divalent copper ion Cu²⁺, or a trivalent cation, such as Al³⁺ or a trivalent iron cation Fe³⁺. In the context of the present invention the term organic cation is used as known to the person skilled in the art and denotes any type of compound cation, e.g., a tetramethylammonium cation N[CH₃]₄⁺. The PQQ salt can comprise PQQ as monovalent, divalent, or trivalent anion. Depending on the valency of the PQQ anion, the PQQ salt contains the necessary number of cations. For example, a PQQ salt comprising a divalent PQQ can contain two monovalent cations, or one divalent cation. For example, when the PQQ salt comprises a trivalent PQQ anion, the salt comprises two trivalent PQQ anions and three divalent cations. In one embodiment of the composition according to the present invention the PQQ salt comprises an inorganic or organic cation. Preferably, the PQQ salt comprises an inorganic cation, e.g., an alkali cation or an alkaline earth cation, since alkali or alkaline earth salts of PQQ have a relatively high solubility in water. In another embodiment of the composition according to the present invention the PQQ salt comprises an alkali cation and/or an alkaline earth cation. The disodium salt of PQQ is the most commonly used form as it has a higher water solubility and is a 40 stable solid with colors from red to brown depending on the level of hydration. PQQ disodium (PQQ*Na₂) forms a stable trihydrate (ca. 12.5% water) and a stable pentahydrate (ca. 20-21% water). The anhydrous material will absorb water to at least the trihydrate form if exposed to ambient conditions. In a preferred embodiment of the composition according to the present invention the PQQ salt comprises a sodium cation, and/or a potassium cation.

It was also found that it needs only small amounts of the biologically active form of PQQ to achieve the beneficial effects of the composition according to the present invention on performance and metabolism in broilers. In a further embodiment the composition according to the present invention further comprises at least 0.05 ppm of the biologically active form of PQQ. Preferably, the composition according to the present invention further comprises from 0.05 ppm to 20 ppm of the biologically active form of PQQ. The recommended PQQ concentration can then be easily adjusted by dissolving the composition in the corresponding amount of water.

It is believed that an N-guanylamino acids, e.g., guanidinoacetic acid, has a positive effect on the efficacy of prebiotics and/or probiotics. It is therefore beneficial to combine an N-guanylamino acid together with a prebiotic and/or probiotic in the composition according to the present invention.

In one embodiment the composition according to the present invention further comprises a prebiotic and/or probiotic.

Preferably, said probiotic comprises a strain of Bacillus spp., in particular a strain of B. subtilis (e.g., DSM 32315 or DSM 32540), B. amyloliquefaciens (e.g., CECT 5940) and/or a mixture of any of these.

In another embodiment the composition according to the present invention further comprises a probiotic comprising a strain selected from B. subtilis (e.g., DSM 32315, or DSM 32540), B. amyloliquefaciens (e.g., CECT 5940) and/or a mixture of any of these.

Bacillus subtilis DSM 32315 has been identified by screening of naturally occurring isolates. It has been deposited with the DSMZ on May 12, 2016 under the provisions of the Budapest Treaty on the International Recognition of the Deposit of Microorganisms for the Purpose of Patent Procedure under the Accession Number as mentioned before in the name of Evonik Degussa GmbH. Bacillus subtilis DSM 32315 is an ingredient of GutCare® from Evonik. GutCare® is a direct-fed microbial solution based on a spore-forming Bacillus subtilis DSM 32315 strain with an inherent capacity to produce a variety of secondary metabolites

Bacillus subtilis DSM 32540 has been identified by targeted screening of naturally occurring isolates. It has been deposited with the DSMZ on Jun. 14, 2017 under the provisions of the Budapest Treaty on the International Recognition of the Deposit of Microorganisms for the Purpose of Patent Procedure under the Accession Number as mentioned before in the name of Evonik Degussa GmbH. Bacillus subtilis DSM 32540 is an ingredient of GutPlus® from Evonik. GutPlus® is a probiotic for gut microbiota management.

Bacillus amyloliquefaciens strain has been deposited in the Spanish Type Culture Collection with accession number CECT 5940. It has not been genetically modified and does not harbour plasmids. Ecobiol® is a feed additive which consists of a natural fast-growing Bacillus amyloliquefaciens CECT 5940. It can improve health and production conditions of animals and help producers to solve quality, profitability, and sustainability challenges.

In addition, the composition according to the present invention may further comprise 5-aminolevulinic acid, which is a pre-cursor of the hem synthesis. More hem in the organism in question means more oxygen present in the animals, which results in an increased agility of the animals. It is also conceivable to include a derivative of 5-aminolevulinic acid into the composition according to the present invention. A suitable salt of 5-aminolevulinic acid is, e.g., an alkali or alkaline earth metal salt, an ammonium salt of 5-aminolevulinic acid or an acid addition salt, e.g., 5-aminolevulinic acid hydrochloride. A suitable derivative of 5-aminolevulinic acid is, e.g., a 5-aminolevulinic acid carrying a masking or protective group at the hydroxy group, e.g., an ester, or at the amino group, e.g., a tert-butyloxycarbonyl, also known as Boc group. Preferably, the one or more masking group(s) will be able to be cleaved of from the 5-aminolevulinic acid under physiological conditions. In case the 5-aminolevulinic acid derivative has two masking or protective group, it is preferred that they are able to be cleaved of under the same conditions at the same time.

In another embodiment the composition according to the present invention further comprises 5-aminolevulinic acid, a derivative thereof, a salt thereof and/or a mixture of any of these.

The composition according to the present invention is not subject to any limitations regarding the number of one or more aforementioned additional components and their individual amounts, provided that said one or more additional components does not adversely affect the beneficial effect(s) of the composition according to the present invention.

The presence of the carbon dioxide producing or providing compound and the gas releasing compound have the effect that the carbon dioxide is released when the compound according to the present invention is dissolved in water. Therefore, the composition according to the present invention can also be considered a fizzy composition. This composition is not subject to any limitations regarding its physical appearance. In the easiest case it is powder, and as such it can already be used in the supplementation of animals' diet. Nevertheless, it is also possible to further process the composition according to the present invention into any conceivable form or physical appearance, e.g., into a tablet, specifically an effervescent or fizzy tablet.

In yet another embodiment the composition according to the present invention the composition is an effervescent tablet.

The composition according to the present invention is suitable for use in the treatment and/or prophylaxis of heat stress, transport stress or any other stress-related conditions in poultry and/or livestock. For example, administration of GAA to poultry reduces the mortality of poultry during transport.

The diet according to the present invention is suitable for use in the treatment and/or prophylaxis of heat stress, transport stress or any other stress-related conditions in poultry and/or livestock, wherein the diet comprises the composition according to the present invention and is administered to poultry and/or livestock.

The term poultry is used in the context of the present invention to denote any kind of domesticated bird, captive raised for its utility. Examples for poultry are domestic fowls, including chickens (or broilers and layers), turkeys, geese, quails, and ducks, raised to produce meat or eggs. Preferably, the term poultry refers to chickens or broilers in the context of the present invention.

The term livestock is used in the context of the present invention to denote domesticated animals raised in an agricultural setting to provide labor and produce diversified products for consumption such as meat, eggs, milk, fur, leather, and wool. In particular, the term livestock is used to denote animals, which are raised for consumption, specifically farmed ruminants, such as cattle, sheep, goats, and pigs.

The term heat stress is used in the context of the present invention to determine the exposure to elevated ambient temperature. Heat stress can be chronic or acute. The term chronic heat stress is used in the context to the present invention to determine an extended period of elevated ambient temperature. In contrast, acute heat stress is understood in the context of the present invention to determine a sudden and short period of extremely high ambient temperatures. In principle, the diet according to the present invention is not subject to a limitation regarding a chronic or an acute heat stress. The term elevated ambient temperature is used in the context of the present invention and in particular in the context of the term chronic heat stress to determine a temperature which is above the comfortable temperature of poultry. As already said above, the temperature comfort zone of birds depends on their age. Older birds are more sensitive to high temperatures. Typically, birds feel comfortable at ca. 21 to 24° C. (70 to 75° F.) and function normally up to ca. 27° C. (80° F.). However, above 27° C. (up to ca. 30° C.), feed consumption drops, while water intake increases. Feed conversion ratios (FCRs) and weight gain decrease in broiler birds, and egg production decreases in layer and breeder flocks. At temperatures from 30 to 32° C. (86 to 95° F.), a significant decline in egg production and egg-shell quality is observed. In layers, the FCR based on egg mass and the FCR per dozen eggs increase as ambient temperature increases. When the temperature exceeds ca. 35 to 37° C. (96 to 100° F.), birds attempt to reduce body heat through severe gular fluttering; however, temperatures in this range result in some degree of mortality. Preferably, a temperature of more than 27° C. and in particular, a temperature of at least 30° C. is an elevated ambient temperature in the context of the present invention. In particular, a temperature in the range from 30 to 40° C. or from 34 to 40° C. is an elevated temperature.

The diet according to the present invention can be administered to poultry being exposed to a temperature of more than 27° C.

The diet according to the present invention can be administered to poultry being exposed to a temperature of at least 30° C., e.g., at least 34° C.

Usually, the elevated temperature to which the poultry is exposed follows a cyclic course: The temperature has a minimum value at night, then steadily increases over the day until it reaches a maximum, and from this maximum the temperature decreases again over night until the minimum value. If the described temperature course extends over several days or weeks, it is also called a chronic cyclic heat stress in the context of the present invention.

The diet according to the present invention can be administered to chronically heat stressed poultry.

The extended temperature period of a chronical heat stress is preferably at least 5 hours a day. Preferably, the extended temperature period or extended period of elevated ambient temperature denotes a period of 5 to 24 hours a day, in particular at least 5, 6, 7, 8, 9, 10, 11, 12, 13, 14, 15, 16, 17, 18, 19, 20, 21, 22, 23 or even up to 24 hours a day.

The diet according to the present invention can be administered to poultry being exposed to a temperature of more than 27° C., for at least 5 hours a day.

In many cases, specifically in southern countries, in particular in subtropical, tropical and in general in those countries near the equator, an elevated temperature is coupled with a higher relative humidity. The term higher relative humidity is used in the context of the present invention to denote a relative humidity of at least 40% on average. Preferably, the relative humidity ranges from 40 to 70% on average, in the context of the present invention, in particular from 50 to 60%, on average.

The diet according to the present invention can be administered to the poultry being exposed to a relative air humidity of at least 40% on average.

The poultry can be exposed to a relative air humidity of at least 45% on average.

In principle, the diet according to the present invention can be administered to poultry in any phase, a multitude of phases, or all phases of feeding poultry, i.e., in any phase, a multitude of phases, or all phases of their lifetime.

The lifetime of laying hens can be divided into a pre-layer phase and three production phases or three production periods, i.e., the initial production phase, the grower juvenile production phase, and the nesting phase, sometimes also called pre-layer phase and phases I to III.

The lifetime of captive-raised birds for meat production can be divided into the three phases of starter, grower, and finisher phase. For example, the whole lifetime of chicken can amount to 39 days, of which the days (d) from d-0 to d-10 are called the starter phase, the days from d-10 to d-21 are called the grower phase and the days from d-21 to d-39 are called the finisher phase. Birds raised for egg production have respectively also different growth and feeding periods. In principle, the diet according to the present invention being administered to chronically heat stressed poultry is not limited to any specific phase or period in the lifetime of poultry. Therefore, the diet can be administered to chronically heat stressed poultry at any conceivable time point in or during any of the phases, i.e., in or during the starter, grower and/or finisher phase. Notwithstanding, it is preferred to administer the diet to chronically heat stressed poultry in or during the finisher phase. The term in with respect to a phase is used in the context of the present invention to denote selected time points, such as hours, days, or weeks, which are not necessarily a continuous period. In contrast, the term during with respect to a phase is used in the context of the present invention to denote to continuous period of hours, days, or weeks.

The diet according to the present invention can be administered to poultry in any phase, a multitude of phases, or all phases of their lifetime.

The diet according to the present invention can be administered to poultry starting from the beginning of the starter phase until slaughter or from the beginning of the grower phase until slaughter.

### EXAMPLES

### 1. Example According to the Invention: Determination of the Dissolution Time for a Fizzy Mixture Comprising GAA

3 g (25.3 mmol) guanidinoacetic acid (GAA, powder, purchased from Gendone, China), 7.9 g (94 mmol) sodium hydrogencarbonate (p.a. grade, purchased from Merck), and 19.1 g (99.4 mmol) citric acid (water free, purchased from Jungbunzlauer) were mixed together for 3 minutes in a batch mill (TubeMill, IKA) to give a fizzy composition comprising GAA.

The thus obtained solid mixture was added to 10 L tap water, which was provided in a beaker. The solid mixture dissolved almost completely during sinking. The mixture was neither stirred nor moved. After 3 minutes there was no solid mixture at the bottom of the beaker.

### 2. Example not According to the Invention: Determination of the Dissolution Time for GAA (without Fizzy Mixture)

A beaker with 10 L tap water was provided and 3 g (25.3 mmol) guanidinoacetic acid (GAA, powder, purchased from Gendone, China) was added. The powder sank to the bottom of the beaker. The mixture was not stirred or moved. After 4 days, no solid material was recognizable any more at the bottom of the beaker.

### 3. Example not According to the Invention: Solubility Test for Four GAA Comprising Preparation of CN 115137016 A

GAA comprising preparations according to CN 115137016 A (see paragraph of CN 115137016 A) were prepared. In detail, the four GAA comprising preparation according to CN 115137016 A were prepared using GAA as powder (purchased from Gendone, China) and using GAA as micro granulate (purchased from Gendone, China). The other chemicals used were sodium sulfate (water free, purchased from Merck), citric acid (monohydrate, purchased from Merck, glucose (purchased from ChemPur), ammonium hydrogen carbonate (purchased from Roth), saccharin sodium salt, sodium cyclamate and xylitol as sweetening agents and ascorbic acid as benefiting powder. In total, 8 mixtures were prepared. The composition of the 4 preparations, each for GAA powder and GAA micro granulates is summarized in Table 3:

TABLE 1
Composition of the eight comparative preparations

| | Prep. | Prep | Prep. | Prep. |
|---|---|---|---|---|
| Compound [g] | 1/5 | 2/6 | 3/7 | 4/8 |
| GAA (powder/micro granulate) | 1.33 | 1.44 | 1.44 | 1.53 |
| sodium sulfate (water free) | 0.67 | 0.42 | 0.27 | 0.15 |
| sweetening agent | 0.03 | 0.16 | 0.27 | 0.29 |
| citric acid | 0.33 | 0.21 | 0.13 | 0.06 |
| glucose | 0.33 | 0.52 | 0.66 | 0.76 |
| vitamin mixture | 0.27 | 0.21 | 0.18 | 0.15 |
| ammonium hydrogen carbonate | 0.03 | 0.04 | 0.06 | 0.06 |
| Total | 3 | 3 | 3 | 3 |

The eight preparations in total were subjected to dissolution tests for determine the time for dissolution. The results are summarized in Table 2.

TABLE 2
Overview of the solubility tests

| Solubility | | GAA Powder/ | Stirred/ | Dissolution time | |
|---|---|---|---|---|---|
| test | Preparation | Microgranulate | unstirred | minutes | days |
| 1 | 1 | Powder | stirred | 5 | |
| 2 | 2 | Powder | stirred | 6 | |
| 3 | 3 | Powder | stirred | 6 | |
| 4 | 4 | Powder | stirred | 6 | |
| 5 | 5 | Microgranulate | stirred | 8 | |
| 6 | 6 | Microgranulate | stirred | 6 | |
| 7 | 7 | Microgranulate | stirred | 5 | |
| 8 | 8 | Microgranulate | stirred | 6 | |
| 9 | 1 | Powder | unstirred | | 3 |
| 10 | 2 | Powder | unstirred | | 3 |
| 11 | 3 | Powder | unstirred | | 3 |
| 12 | 4 | Powder | unstirred | | 3 |
| 13 | 5 | Microgranulate | unstirred | | 3 |
| 14 | 6 | Microgranulate | unstirred | | 3 |
| 15 | 7 | Microgranulate | unstirred | | 3 |
| 16 | 8 | Microgranulate | unstirred | | 3 |

In the 8 stirred solubility tests, the four preparations with GAA powder gave faster dissolution times than the other four preparations with GAA micro granulates. However, all 8 comparative preparations gave longer dissolution times than the mixtures according to the present invention. In the 8 unstirred solubility tests, there were no significant differences between the preparations with GAA powder and the preparations with GAA micro granulates. Rather, all 8 preparations according to CN 115137016 A, independent if they contain GAA powder or GAA micro granulates are not suitable for use in unstirred water tanks.

### 4. Example According to the Invention: Solubility Test for a Fizzy Composition Comprising GAA and GutCare® (without Maltodextrin)

3 g (25.3 mmol) Guanidinoacetic acid (GAA, powder, purchased from Gendone, China), 7.9 g (94 mmol) sodium hydrogencarbonate (p.a. grade, purchased from Merck), 19.1 g (99.4 mmol) citric acid (water free, purchased from Jungbunzlauer), and 97.8 mg dried biomass GutCare® (without maltodextrin, calculated with 0.92×10¹¹ CFU/g, from Evonik Espana y Portugal, S.A.U, Leon) were mixed together for 3 minutes in a batch mill (TubeMill, IKA) to give a fizzy composition comprising GAA and GutCare®.

The thus obtained fizzy composition was added to 10 L tap water, which was provided in a beaker. After 10 minutes, samples were taken from the surface, the middle and the bottom, and the spore distribution was determined in these samples. The results are 5.2×10⁵ CFU/mL (surface sample), 3.6×10⁵ CFU/mL (middle sample), and 3.1×10⁵ CFU/mL (bottom sample).

### 5. Example According to the Invention: Solubility Test for a Fizzy Composition Comprising GAA and GutCare® (with Maltodextrin)

3 g (25.3 mmol) Guanidinoacetic acid (GAA, powder, purchased from Gendone, China), 7.9 g (94 mmol) sodium hydrogencarbonate (p.a. grade, purchased from Merck), 19.1 g (99.4 mmol) citric acid (water free, purchased from Jungbunzlauer), and 81.1 mg dried biomass GutCare® (with maltodextrin, calculated with 1.1×10¹¹ CFU/g, from Evonik Espana y Portugal, S.A.U, Leon) were mixed together for 3 minutes in a batch mill (TubeMill, IKA) to give a fizzy composition comprising GAA and GutCare®.

The thus obtained fizzy composition was added to 10 L tap water, which was provided in a beaker. After 10 minutes, samples were taken from the surface, the middle and the bottom, and the spore distribution was determined in these samples. The results are 6.6×10⁵ CFU/mL (surface sample), 1.1×10⁶ CFU/mL (middle sample), and 7.2×10⁵ CFU/mL (bottom sample).

### 6. Example According to the Invention: Solubility Test for a Fizzy Composition Comprising GAA and Ecobiol®

3 g (25.3 mmol) Guanidinoacetic acid (GAA, powder, purchased from Gendone, China), 7.9 g (94 mmol) sodium hydrogencarbonate (p.a. grade, purchased from Merck), 19.1 g (99.4 mmol) citric acid (water free, purchased from Jungbunzlauer), and 22.5 mg dried biomass Ecobiol® (calculated with 4×10¹¹ CFU/g, from Evonik Espana y Portugal, S.A.U, Leon) were mixed together for 3 minutes in a batch mill (TubeMill, IKA) to give a fizzy composition comprising GAA and Ecobiol®.

The thus obtained fizzy composition was added to 10 L tap water, which was provided in a beaker. After 10 minutes, samples were taken from the surface, the middle and the bottom, and the spore distribution was determined in these samples. The results are 2.2×10⁶ CFU/mL (surface sample), 1.3×10⁶ CFU/mL (middle sample), and 9.3×10⁵ CFU/mL (bottom sample).

### 7. Example According to the Invention: Solubility Test for a Fizzy Composition Comprising GAA and 5-Aminolevulinic Acid

3 g (25.3 mmol) Guanidinoacetic acid (GAA, powder, purchased from Gendone, China), 7.9 g (94 mmol) sodium hydrogencarbonate (p.a. grade, purchased from Merck), 19.1 g (99.4 mmol) citric acid (water free, purchased from Jungbunzlauer), and 0.16 g (0.96 mmol) 5-aminolevulinic acid (5-Ala, as hydrochloride, purchased from Haihang Industries, China) were mixed together for 3 minutes in a batch mill (TubeMill, IKA) to give a fizzy composition comprising GAA and 5-aminolevulinic acid.

The thus obtained fizzy composition was added to 10 L tap water, which was provided in a beaker. After 10 minutes, samples were taken from the surface, the middle and the bottom, and the amount of 5-ala was determined by means of HPLC. The results are summarized in the table 1:

TABLE 3
Results for the HPLC determination of 5-Ala.

| Sample | Area 5-Ala |
|---|---|
| Surface | 12.2 |
| Middle | 13.1 |
| Bottom | 14.0 |
| Mean | 13.1 |
| Standard deviation | 0.9 |
| Variation coefficient | 0.069 |

### 8. Example According to the Invention: Solubility Test for a Fizzy Composition Comprising GAA and PQQ

3 g (25.3 mmol) Guanidinoacetic acid (GAA, powder, purchased from Gendone, China), 7.9 g (94 mmol) sodium hydrogencarbonate (p.a. grade, purchased from Merck), 19.1 g (99.4 mmol) citric acid (water free, purchased from Jungbunzlauer), and 1.9 (0.004 mmol) PQQ-disodium salt pentahydrate (PentaQQ, Anthem Biosciences Pvt., Ltd.) were mixed together for 3 minutes in a batch mill (TubeMill, IKA) to give a fizzy composition comprising GAA and PQQ.

The thus obtained fizzy composition was added to 10 L tap water, which was provided in a beaker. After 10 minutes, samples were taken from the surface, the middle and the bottom, and the amount of PQQ was determined by means of HPLC. The results are summarized in the table 2:

TABLE 4
Results for the HPLC determination of PQQ.

| Sample | Area PQQ |
|---|---|
| Surface | 1144 |
| Middle | 1208 |
| Bottom | 1307 |
| Mean | 1218 |
| Standard deviation | 78.9 |
| Variation coefficient | 0.065 |

1. A composition, comprising:
an N-guanylamino acid;
a carbon dioxide producing compound; and
a gas releasing compound,
wherein an equivalent ratio of the gas releasing compound to the carbon dioxide producing compound is 1 or more, and
wherein a molar ratio of the carbon dioxide producing compound to the N-guanylamino acid is 1 or more.

2. The composition of claim 1, wherein the carbon dioxide producing compound is an alkali hydrogen carbonate, alkaline earth hydrogen carbonate, ammonium hydrogen carbonate, alkali carbonate, an alkaline earth carbonate, or a mixture of any of these.

3. The composition of claim 1, wherein the carbon dioxide producing compound is sodium hydrogen carbonate, potassium hydrogen carbonate, ammonium hydrogen carbonate, or a mixture of any of these.

4. The composition of claim 1, wherein the gas releasing compound is a solid organic acid.

5. The composition of claim 1, wherein the gas releasing compound is citric acid, tartaric acid, malic acid, or a mixture of any of these.

6. The composition of claim 1, wherein the equivalent ratio of the gas releasing compound to the carbon dioxide producing compound is in a range of from 1 to 3.

7. The composition of claim 1, wherein the equivalent ratio of the gas releasing compound to the carbon dioxide producing compound is at least 1.05:1.

8. The composition of claim 1, comprising more than 4 wt.-% of the N-guanylamino acid, based on a total weight of the composition.

9. The composition of claim 1, wherein the N-guanylamino acid is guanidinoacetic acid.

10. The composition of claim 1, further comprising:
a pyrroloquinoline quinone salt.

11. The composition of claim 1, further comprising:
a pyrroloquinoline quinone salt comprising an alkali cation and/or an alkaline earth cation.

12. The composition of claim 1, comprising:
a prebiotic and/or probiotic.

13. The composition of claim 1, further comprising:
a probiotic comprising a B. subtilis strain, B. amyloliquefaciens strain, or a mixture of any of these.

14. The composition of claim 1, further comprising:
5-aminolevulinic acid, a derivative thereof, a salt thereof, or a mixture of any of these.

15. The composition of claim 1, formed as an effervescent tablet.

16. The composition of claim 1, further comprising:
a probiotic comprising DSM 32315, DSM 32540, CECT 5940, or a mixture of any of these.

17. The composition of claim 1, wherein the carbon dioxide producing compound comprises sodium hydrogen carbonate, potassium hydrogen carbonate, and/or ammonium hydrogen carbonate, and
wherein the gas releasing compound comprises citric acid, tartaric acid, and/or malic acid.

18. The composition of claim 1, further comprising:
a pyrroloquinoline quinone salt,
wherein the carbon dioxide producing compound comprises sodium hydrogen carbonate, potassium hydrogen carbonate, and/or ammonium hydrogen carbonate, and
wherein the gas releasing compound comprises citric acid, tartaric acid, and/or malic acid.

19. The composition of claim 1, further comprising:
a pyrroloquinoline quinone salt;
a prebiotic and/or probiotic; and
5-aminolevulinic acid, optionally as a salt,
wherein the carbon dioxide producing compound comprises sodium hydrogen carbonate, potassium hydrogen carbonate, and/or ammonium hydrogen carbonate, and
wherein the gas releasing compound comprises citric acid, tartaric acid, and/or malic acid.
